(19) United States
(12) Patent Application Publication
(10) Pub. No.: US 2005/0132039 A1
(43) Pub. Date: Jun. 16, 2005

(54) Data processing system with automatable administration and method for automated administration of a data processing system

(75) Inventor: Klaus Hartung, Salzkotten (DE)

Correspondence Address: COHEN, PONTANI, LIEBERMAN & PAVANE, Suite 1210, 551 Fifth Avenue, New York, NY, 10176, US

(73) Assignee: Fujitsu Siemens Computers GmbH, Munich (DE)

(21) Appl. No.: 10/998,263

(22) Filed: Nov. 24, 2004

(30) Foreign Application Priority Data
Nov. 25, 2003 (DE) 103 54 938.2

(51) Int. Cl. G06F 15/173

(52) U.S. Cl. 709/223

(57) ABSTRACT

A data processing system with a plurality of hardware and software components, wherein the components can be controlled by finite automata. The data processing system includes at least one finite sample automaton which is defined so as to be suitable for controlling and monitoring pre-determined component types. Finite automata can be configured for the control of one component on the basis of the defined sample automaton (automata) in conjunction with component-specific parameters, and an event-controlled automaton control component (5) is provided which is constructed for the configuration, instantiation and deletion of finite automata.

### CROSS-REFERENCE TO RELATED APPLICATIONS

This patent application claims the priority of German patent application 103 54 938.2 filed 25 Nov. 2003, the disclosure content of which is hereby incorporated by reference.

### FIELD OF THE INVENTION

The invention relates to a data processing system with a plurality of hardware and software components, wherein the components are controllable by finite automata. In addition, the invention relates to a method for controlling a data processing system with a plurality of hardware and software components in which the components are controllable by finite automata.

The origin of this invention lies in the field of controlling large data processing systems, especially of server farms, and specifically with regard to their administration and reliability. In this situation, the term “administration” means setting up the machine, i.e., its installation and turning on and shutting down. Events that can occur in this field are for example the addition of a new machine, for example, a new blade server, the failure of a machine, an overload message or an underload message.

Individual hardware or software components of the data processing system are controlled by finite automata which are also called state automata.

### BACKGROUND OF THE INVENTION

### Basic Terms

Finite automata are omnipresent in the control of processes. The substantially consist of a machine table wherein each entry is a tuple (Ferretti, “Dictionary of Electronics, Computing and Telecommunications German-Englisch/English-German”) consisting of:

old state,

event,

new state and

action.

In this situation the machine tables are fixedly pre-defined. These machine tables can also be represented as a graph. Thus, in the following the terms finite automaton or graph are used synonymously according to which seems the more suitable. FIG. 13A shows a machine table with a singular line. The old state ZA is converted into the new state ZN on arrival the event E by executing the action A. The first graph in FIG. 13B with the shortened notation given at the edge has the same meaning. An edge in a graph according to FIG. 13B is the line which stands for the transition from state ZA to state ZN.

Depending on which meaning the finite automaton is to have, restrictions on the quantity of nodes and edges are defined. Thus, for example, a distinction is frequently made between dependence graphs in FIG. 14A and state graphs in FIG. 14B. In the dependence graph the nodes D and E are directly dependent on C. The direction of the edges indicates the dependence. Such graphs can/must contain no cycles. Known cluster managers, i.e., programs for controlling a combination of a plurality of computers operate with dependence graphs. Then, the quantity of states is fixedly defined, i.e., for example, online or offline and the results are also fixedly pre-defined and are delivered via sensors.

For the solution of a complex problem, in this case the administration of a large data processing system, this is first broken down into parts which can be solved with finite automata. The more complex the problem, the more finite automata are obtained and the greater the effort which must be put into the configuration of the finite automata and in their administration.

Conventional solutions for the administration of large data processing systems are based on the personal activity of an administrator. In the simplest case, software, a so-called SNMP Manager, helps to represent events and states of the data processing system. They substantially serve to clearly represent the problem. The administrator of a server farm is basically a “finite automaton” who controls everything manually.

As a further step in simplifying the administration, dependence graphs are used in order to structure complex operating steps and thus make their sequence automatically controllable. The dependence graphs are implemented in the so-called cluster managers which guarantee the high availability of entrusted services, (i.e., services running on the cluster). This is a widely used type of administration of data processing systems today. In this case, a closed control loop is formed by sensors which monitor the processes to be controlled and notify changes to the cluster manager. This control loop is important and stays in this form even in the solution according to the invention which is presented below.

### Problem Of Multiplicity Of Versions

However, the cluster managers have a number of disadvantages. A first problem arises from the multiplicity of versions and adverse effects of other programs. The cluster managers are used on each machine together with the services which they must monitor. Thus, in the worst case a mutual influencing can result through which a correct control of cluster in every operating situation can be impaired. In other words, the cluster manager must abide by the game rules inside the machine which are predefined by the applications running thereon. In other words, the applications running on the cluster determine the rules of how the control software has to control the system. Therefore, the development of the control software follows the development of the applications. This especially relates to the software scenery (i.e., the totality of applications and services running on a cluster) on these machines. Thus, the cluster managers are directly subject to the rapid further development of the machines and operating systems and must be continuously revised with regard to new/modified functions in the operating systems and new versions of the services. To illustrate this problem FIG. 15 shows a fictitious but therefore simple interlocking of SOLARIS and ORACLE release deadlines. In reality the interlockings are far more complex and require an increasing expenditure on the part of the manufacturer of cluster managers to keep up with the progress.

### Problem Of Complexity

A further problem is the complexity of the process in a cluster with a plurality of nodes. Cluster managers have a distributed intelligence because each machine has its independent cluster manager which can act automatically in the worst case. This distribution of intelligence to many machines results in very complex processes in the cluster software itself, for example, the solution of the split brain syndrome (this term refers to problems arising when “intelligence” is split among a plurality of machines because then a plurality of control mechanisms try to solve the same problem which can lead to uncoordinated decisions and actions). Basically, the practical use of cluster managers is restricted to only a few machines per cluster. Experience shows that the predominant number of machines per cluster is two.

The dependence graphs in the cluster managers have a fixed meaning. The passage through the graph is fixedly defined (see FIG. 16B). The provision of a service is accomplished from leaf node B to root node W and the shutdown in the reverse direction. The terms leaf node and root node are known from graph theory. Root nodes have stable states while leaf nodes are starting or transition nodes. When considered as a function of time, a type of staircase is obtained (FIG. 16A). It is not possible to pass through a part graph many times. The stable states of the root node are decisive, either ready or not ready. As a particular restriction it should be mentioned that the number of simultaneous state transitions in a graph is severely limited and in the worst case, only one event at one time can be reacted to. Between the two stable states there is no path other than via this ‘staircase’ (FIG. 16A). In this situation, all nodes are affected every time and there are no shortcuts.

### Problem Of Simultaneous Events

There are inactive events where the arrival of events is not processed. This unfortunately means that cluster managers do not always automatically recognise when ‘your’ service is available without this being notified to the cluster manager.

### Problem Of The Configuration

New services of a new or a known type must always be configured manually by a system administrator. The graphs of the cluster manager contain data for this purpose which are matched to the configuration of the cluster. The expenditure involved in adapting the graphs of the cluster manager to a modified configuration is correspondingly high. Automatic adaptation is not possible, in particular, the cluster software cannot reconfigure itself. The administration of the services or the applications, i.e., for example, the starting and stopping is always subordinate to the cluster managers. The cluster manager must first be informed, because otherwise actions are started which are unnecessary, for example because the service was intentionally stopped. Actions of a system administrator which act directly on a service or an application, can result in faults in the system because the cluster manager detects the change and assumes an error and if appropriate, takes countermeasures.

In particular, the cluster managers or the graphs are very prone to changes in the configuration of the services. A change in a service can have the result that planned measures of the cluster manager are wasted or cannot be implemented.

In cases of usage “foreign to the purpose” in server farms, dependences between machines which do not exist naturally must frequently be found artificially because the cluster managers only prepare dependence graphs.

The node types of the dependence graphs themselves are limited to a few types, usually AND and OR nodes. Thus, no complex node intelligence is feasible and the graphs for large scenarios (refers to situations having many possible problems and which require many decisions and many actions) become very unclear. In addition, effects on the structure are obtained from the meaning of the graphs:

a root node must be defined,

there are no cycles,

leaf nodes must be present and have a well-defined task,

fixed node types are allocated to single levels of the dependence graphs, for example the son nodes to the roots. (A son node describes the level of a node with respect to a root node. The first node next to a root node is a son node).

The further development of server farms with regard to visualisation concepts for data and machines makes much in cluster managers superfluous. Thus, for example, the complicated treatment of mount points is completely unnecessary if server farms work with NAS-coupled disk systems. The simplification of cluster managers is obtained if no complex method is needed any more to provide operating means. In former server forms, it was difficult to provide exactly one operating means per cluster and not several operating means. An example for such an operating means is mount points. If for a hard disk (one device) several mount points are provided, a proper operation cannot be achieved.

### Steps For Simplifying The Administration

In large server farms SNMP (Simple Network Management Protocol) is frequently used as ‘event carrier’. This should certainly simplify the administration of server farms but a new problem is obtained, namely that events are not always notified, can overtake themselves or arrive much too late. Graphs must be basically fixed. Every feasible situation, that is every feasible combination of event and state must appear. This results in graphs which are very complex and therefore difficult to control. This is mostly the reason for seeking other solutions. The result is that large server farms are too complex in order to be visible at a glance, extendable by means of simple automata or controllable.

### Consequences For Data Processing Systems According To The Prior Art

This all has the result that large server farms must be administered manually which presents the companies with ever greater problems. Even if every machine is so to speak fixedly allocated a administrative automaton, this would still need to be provided with the respective data manually, e.g. the internet address, before it could be started. Expansions and reductions of the machine park thus cannot be executed automatically. This particularly applies when new machines must be put into operation under high-load conditions.

### SUMMARY OF THE INVENTION

One object of the invention is to provide a data processing system which makes it possible to achieve a flexible administration and especially a higher degree of automation.

Another object of the present invention is to provide a method with which the administration of a data processing system can be automated.

These and other objects are attained in accordance with one aspect of the invention directed to a data processing system with a plurality of hardware and software components, wherein the components can be controlled by finite automata. At least one finite sample automaton is defined which is suitable for controlling and monitoring pre-determined component types wherein finite automata can be configured for controlling one component on the basis of the defined sample automata in conjunction with component-specific parameters. An event-controlled automaton control component is provided which is constructed for the configuration, instantiation and deletion of finite automata.

Another aspect of the invention is directed to a method for controlling a data processing system with a plurality of hardware and software components, wherein the components can be controlled by finite automata. Such method comprises at least one finite sample automaton which is suitable for controlling and monitoring pre-determined component types, wherein finite automata can be configured for the control of one component on the basis of the defined sample automaton in conjunction with component-specific parameters. An event-controlled automaton control component is applied to configure, instantiate or delete the finite automaton(s).

In the execution of a data-processing system according to an aspect of the invention or in the method according to an aspect of the invention, it is advantageous that by using sample automata in conjunction with the automaton control component, finite automata can be configured and instantiated automatically at run-time without the intervention of a system administrator being required. The configuration and instantiation takes place in an event-controlled manner wherein events can be transmitted automatically from services or applications of the data processing system or manually by a user or system administrator. Messages are transmitted, which are based on the event and, in addition to the type of event, contain data which, for example, includes additional information on the origin of the message or boundary conditions when the event occurs. For simplicity, the following will only talk about ‘event’.

In order to be able to process a large data processing system, with the aid of finite automata, this is first broken down into parts which can be solved with finite automata. In this case, both hardware and software components are controlled and monitored by finite automata. In the definition of a finite sample automaton, the numbers of nodes and edges must be specified, the actions must be defined and the events are to be specified. The most important thing in the definition of sample automata is that the graph, the so-called sample automaton, must remain independent of the parameters, hereinafter called data, with which it is to work in order to be generally valid. Sample graphs or sample automata are thus obtained which are later provided with special data and implement individual solutions for the same type of importance.

In contrast thereto, known cluster managers for example store the names of operating means as attributes of a node. Thus, the graph or automaton containing such nodes is no longer a sample graph or sample automaton. For every feasible component, a component-specific finite automaton must be provided. Since this is not possible in practice, it is necessary to have recourse to a system administrator which executes the necessary adaptations manually.

After defining finite automata, the automata must be configured in an event-controlled manner, that is provided with specific data, instantiated, that is bringing to implementation, or deleted. These steps can be accomplished automatically, for which purpose the event-controlled automaton control component is provided. During the instantiation of the finite automata the number of automata created and the frequency of creation should be monitored. For this purpose a type of superordinate intelligence is required which is formed precisely by the automaton control component.

Specifically during the administration of large server farms this automatic system acquires major importance with respect to the generally small number of available system administrators.

In an advantageous embodiment of the data processing system it is favourable to arrange the automaton control component on a separate computer unit, that is outside the machines that to be administered. As a result, the control of the machines is independent of the services and applications running on the machines. In this case, it is especially advantageous if the separate computer unit is set up as highly available while the separate computer unit for its part is monitored by a cluster manager.

In the configuration of the finite automata it is advantageous to provide special nodes which are hereinafter also called intelligent nodes. At these intelligent nodes it is possible to have branchings, as shown in FIG. 14B. Such state graphs with intelligent nodes are simpler and especially have cycles. The graph shown in FIG. 14B cannot be represented using the dependence graphs described initially. In addition, this graph has a special feature, the state Z5. Via this state many different cycles are possible.

By definition, different graphs are independent of one another. If there is a connection between graphs, then this goes beyond pure graph theory. The nodes of a dependence graph as well as the ‘normal’ nodes of the state graph from FIG. 14B have no intelligence and basically only store the current state.

Intelligent nodes are used in an advantageous embodiment of the invention to capture errors and handle them in a suitable fashion. Operating states which were not predicted when compiling the graph can thus be supplied with a suitable automatic handling. The graph itself remains simple.

In summary, one solution according to an aspect of the invention has the advantages that a control of the entire data processing system is formed, which

can be detached from that being controlled and can be highly available,

operates with finite automata/sample graphs which are automatically configured, created and destroyed,

can execute every type of process control by means of state graphs because the graphs have no pre-defined meaning, there is in particular no restriction in the configuration of the graphs and thus cycles are not only possible but definitely desired; the presence of ‘intelligent’ node types highly simplifies the sample graphs in this case,

supports parallel event processings and

also allows changes of graphs under defined conditions, even makes non-deterministic state transitions possible and thus makes a class of problems accessible which hitherto could barely be handled algorithmically.

### BRIEF DESCRIPTION OF THE DRAWINGS

FIG. 1 is a first simple exemplary embodiment of a data processing system according to the invention,

FIG. 2 is the EDP environment for a second complex exemplary embodiment of a data processing system according to the invention,

FIG. 3 is a schematic diagram of a data processing system with server and memory virtualisation,

FIG. 4 is the data processing system from FIG. 3 with additional control computers,

FIG. 5 shows the structure of the data base,

FIG. 6 shows filing system entries of finite automata,

FIG. 7 is a graphical representation of a finite automaton,

FIG. 8 shows the structure of a finite automaton,

FIG. 9 shows the generation and addressing of event-based messages,

FIG. 10 shows a detailed representation of the automaton-control component,

FIG. 11 is a graphical representation of an automaton with an intelligent node,

FIG. 12 shows the interaction of a plurality of automata,

FIGS. 13A and 13B show basic diagrams of finite automata,

FIG. 14A is a dependence graph,

FIG. 14B is a state graph,

FIG. 15 shows the interlocking of software versions with the x-axis eing program versions of PCC and the y-axis being program versions of SOLARIS and ORACLE,

FIG. 16A shows a diagram with the state profile of a dependence-graph-controlled process, with the x-axis being time and the y-axis being the operating state of a process

FIG. 16B shows the dependence graph corresponding to FIG. 16A.

### DETAILED DESCRIPTION OF THE DRAWINGS

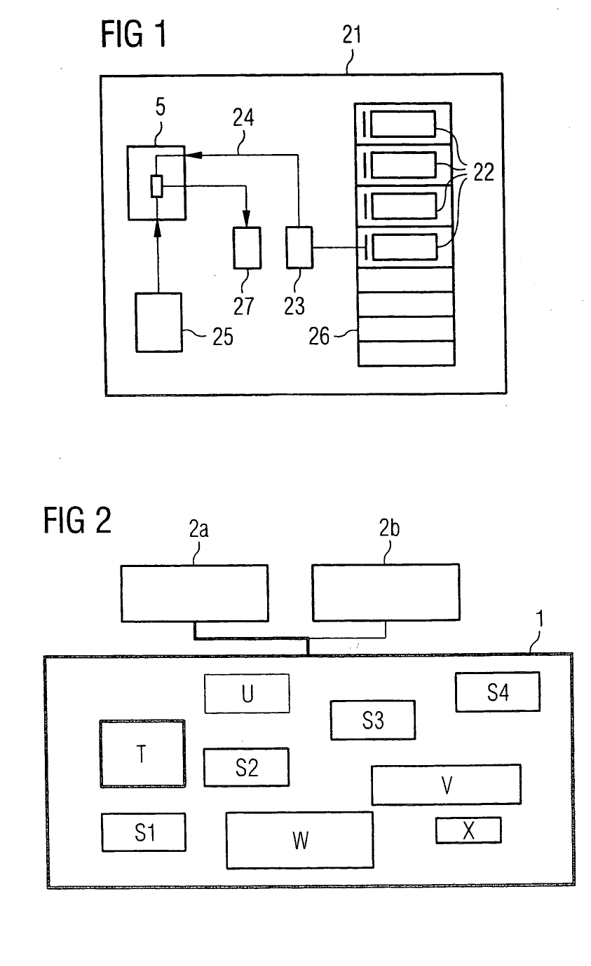

A first simple exemplary embodiment to explain the basic function of a data processing system set up according to the invention is the extension of the data processing system by hot plug addition of a blade server 22, as shown in FIG. 1. In this situation, an event 24 is generated by the hardware of the chassis 26 or by the service 23 monitoring this plug location and is sent to an automaton control component 5. This component can respond automatically by selecting a suitable sample automaton from a supply 25 of sample automata available to it, in conjunction with technical data of the blade server which in the present exemplary embodiment are contained in the event 24 and its address configures a finite automaton which is used to control and monitor the blade server. This automaton is instantiated, that is brought into execution as service 27 and can now be used to control and monitor the blade server 22.

For a detailed explanation of the invention a complex generic data processing system is first described which is the basis for the invention. Such a data processing system is shown schematically in FIG. 2. Servers S1 to S4 are each blade servers of the same design. The computers T . . . X are conventional machines of any type. The entirety of the machines is a server farm. An arrangement of many machines is designated as a server farm. A particular manifestation of a server farm are the so-called blade servers. In these an entire server with processor, main memory, hard disks etc. is accommodated in each case on a plug card. For example, 20 servers can be arranged next to one another in a plug-in module of a rack. A server farm with up to 300 servers can thus be accommodated in a single rack. Connected to the server farm are two control computers 2a and 2b which for their part form a cluster. Communication between the server farm and the control computers 2a and 2b is made via SNMP.

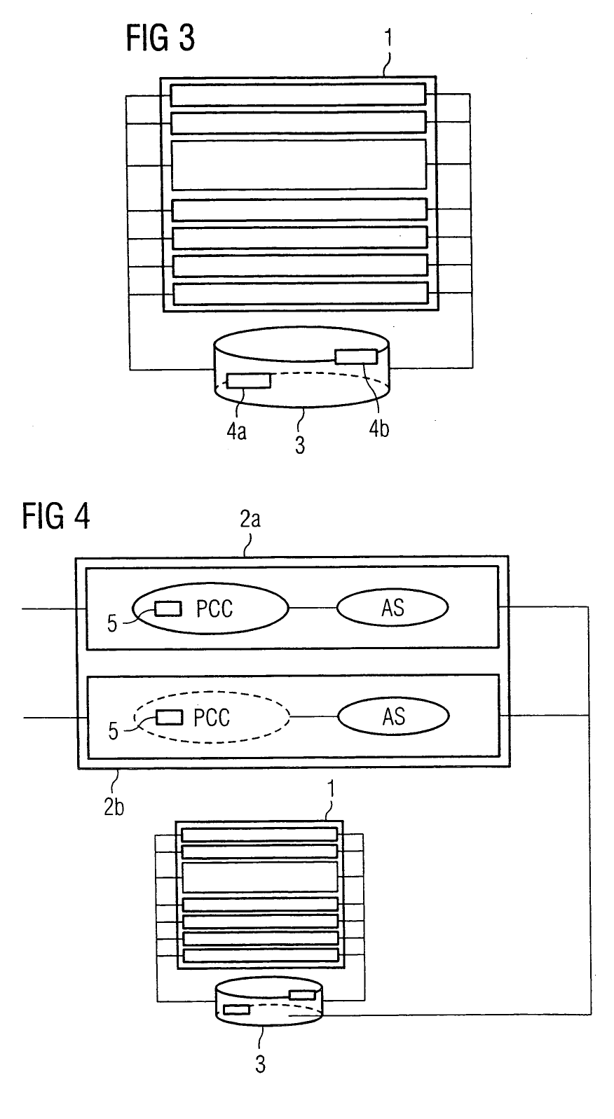

In a more complex exemplary embodiment it is now shown how the problem of monitoring and controlling server farms can be solved in this environment using finite automata. For reasons of simplification, however, not all the individual services which are provided within the server farm are considered but the smallest monitoring and administration unit in this example is a machine. However, the principle can be applied to all services within a server farm. A server farm which is already arranged for minimal administration expenditure by means of server and storage virtualisation is considered. An important feature is the NetBoot property (ability to boot from the network, without the local operating system), i.e., the machines of the server farm 1 no longer have their data on a private disk but as part of the storage virtualisation, the software of an entire machine, the so-called ‘image’ 4a or 4b can be arbitrarily distributed to other machines, if the basic architectural features match (FIG. 3). In this scenario the booting of machines via the network (NetBoot) is accomplished from a central memory unit 3. A control software, hereinafter called PCC (Prime Cluster Control Center, available from Fujitsu Siemens), automatically provides for the basic configuration of the memory unit and central services such as DHCP (Dynamic Host Configuration Protocol used, for example, for the dynamic assignment of IP-addresses in a LAN) etc. Part of the control software PCC is also an automaton control component 5.

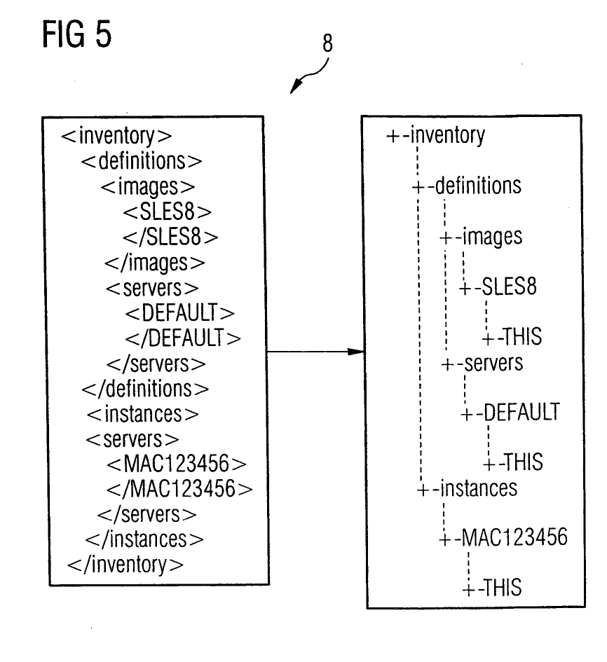

With the additional control computers, which are also called control nodes (FIG. 4), a complete scenario is obtained. The two control nodes 2a and 2b form a cluster with regard to their high availability. The control software PCC is active on precisely one of these two machines. An alarm service AS is connected, which displays the displays of incoming SNMP events with their contained data and can instigate simple actions, such as sending an e-mail or dispatching an SMS. The alarm service AS is quasi “fed” from PCC. The data from PCC are located in the memory unit 3 in exactly the same way as the data from applications of the server farm 1. This means that the memory unit 3 is designed to be highly available in any case.

In this example, PCC (re-)organises the machines S1 . . . S4 and T . . . X of the server farm 1 as a whole, i.e., if a new machine ‘appears’, the necessary infrastructure is provided on the basis of this event so that the new machine is capable of running without administrator intervention. If one machine of the server farm fails, PCC reorganises the distribution of the images on the servers S1 . . . S4 such that the failed image can run on another machine. In this case, operation of the unaffected machines is not disturbed.

All data from PCC are administered in a database 8 in an XML-conformant manner. However, since the time requirement for the processing of such formatted data is very high, on starting PCC (see FIG. 5), the data are brought into a tree structure which can be derived directly from the XML structure. For securing or displaying, the tree structure is converted back into an XML-conformant representation again. In this case, an XSLT image is used to display the data, which is substantially processed on pages of a browser. This scenario does not belong to the substantial matter of this invention and thus is not considered further. It should be noted however, that all accesses to the data of a machine are addressed with the MAC address of the LAN controller, which is used for booting. This has the major advantage that machines which have not yet been switched on or which have failed, can still be handled since the MAC address of a LAN controller is static and unique worldwide and can also be established on switched-off machines.

Within the scope of this invention, the hardware and software components are controlled using finite automata. A finite automaton is a named script in the environment described which is registered in the configuration in the automaton control component and thereby receives a unique object identification worldwide. The finite automaton is connected to an event via this object identification. Thus, for example the event having the name ‘s31 ServerBladeAdded’ has the number ‘.1.3.6.1.4.1.7244.1.1.1.0.1606’. This script processes the machine table and communicates with other scripts of finite automata. In addition, such a finite automaton or a script ensures that an UNDO log is kept for all actions which have been carried out in connection with an event so that in the event of failure of a control node 2a or 2b, the started actions can be reset. A finite automaton is thus only active when an event is to be handled.

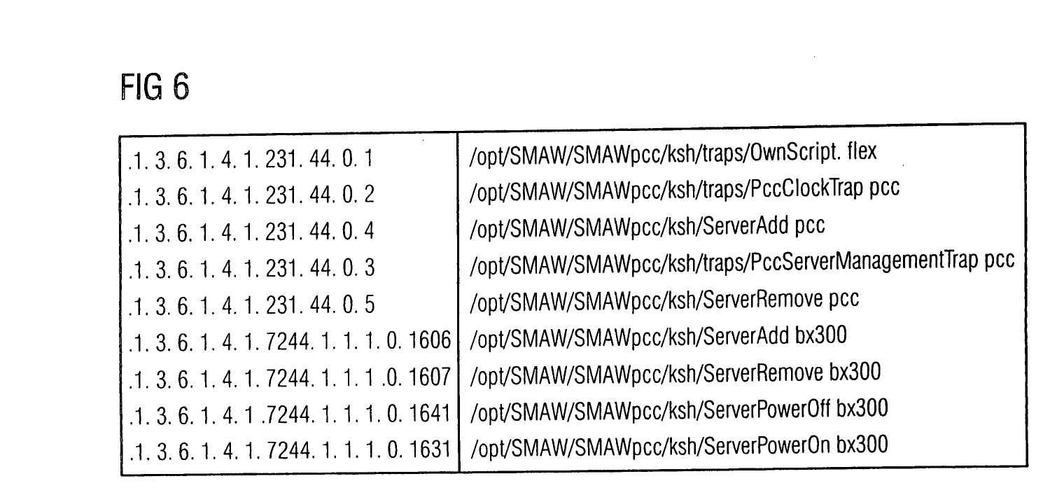

When PCC is switched on, all events which are to be handled are registered for a sample automaton, i.e. the filing system of the automaton manager receives two-tuples of the type script name—SNMP object ID. These allocations can be changed arbitrarily and also dynamically. More than one script for an event can also be registered, as shown in FIG. 6.

A finite automaton close to reality or a filing system for the function ‘NetBoot’ is shown graphically in FIG. 7. The stable states CONFIGURED, MAINTENANCE, ON, NONE, FAILED, OFF and INCOMPLETE are named in upper case. The intermediate states have three dots at the end of the name. For simpler identification of intelligent decision nodes the edge designation “REST?CheckServerState” is used. At this point a further simplification for the ‘building’ of finite automata may be mentioned. Not all possible events must always be specified in the finite automaton. The contraction REST precisely designates the edge which is selected when no singular edge is available for an event. Such an edge usually leads to an intelligent node which decides where the branching should go. In the case of the graph in FIG. 6, the intelligent node is the node “checking . . . ”. In this transition state the current server status is checked and depending on the result of the checking, is branched to the stable states FAILED, ON, etc. The stable states are only left when an event arrives. Assuming that the checking result in the node “checking . . . ” was positive, that is “on”, the state “ON” then becomes active. After an event “DEL!RemoveServer” has occurred, the automaton goes over into the state “unconfiguring . . . ” in order to then reach the stable state “OFF” provided that no errors have occurred during the process “unconfiguring . . . ”.

With the start of both control nodes 2a and 2b it is decided which of these machines becomes the active one. The other machine certainly continues to receive the events but does not execute any processing. With the arrival of an event in the control node 2a or 2b, the data are read by the automaton manager 5. In order to ensure that in the event of failure of one of the two control nodes 2a or 2b, an event is not lost nor handled many times, all the data of all the events are stored so that even in the event of a failure, the corresponding data are available to the replacement PCC on the other control node. For this purpose the automaton control component 5 writes the data into a ‘memory mapped’ file which is located in the memory unit 3. When the replacement PCC starts to run, all the data are available to the automaton control component 5 and the processing proceeds seamlessly with the addition that all commands are previously reset via the UNDO log.

With the arrival of an event at the active automaton control component 5, the data contained are removed and inserted as a two-tuple of the type SNMP-Object-ID=value into the process environment. In this way the data are simply available for all subsequent processing instances. In precisely this way also the messages of one finite automaton reach the other finite automaton using the active automaton control component as intermediary. By means of keys contained in the data, usually a MAC address, the current state is determined and together with the present event, the edge is selected in the graph and the corresponding action started.

If the action should involve a decision, the event is handled as a new event and the machine table is consulted again in order to carry out the next state transition. In this case, the following basic rule applies to all graphs, that there are stable states and unstable states. Stable states are attained and the finite automaton ends the processing in order to wait for the next event. In the case of unstable states, the processing proceeds until a stable state is reached. There can be arbitrarily many stable or unstable states.

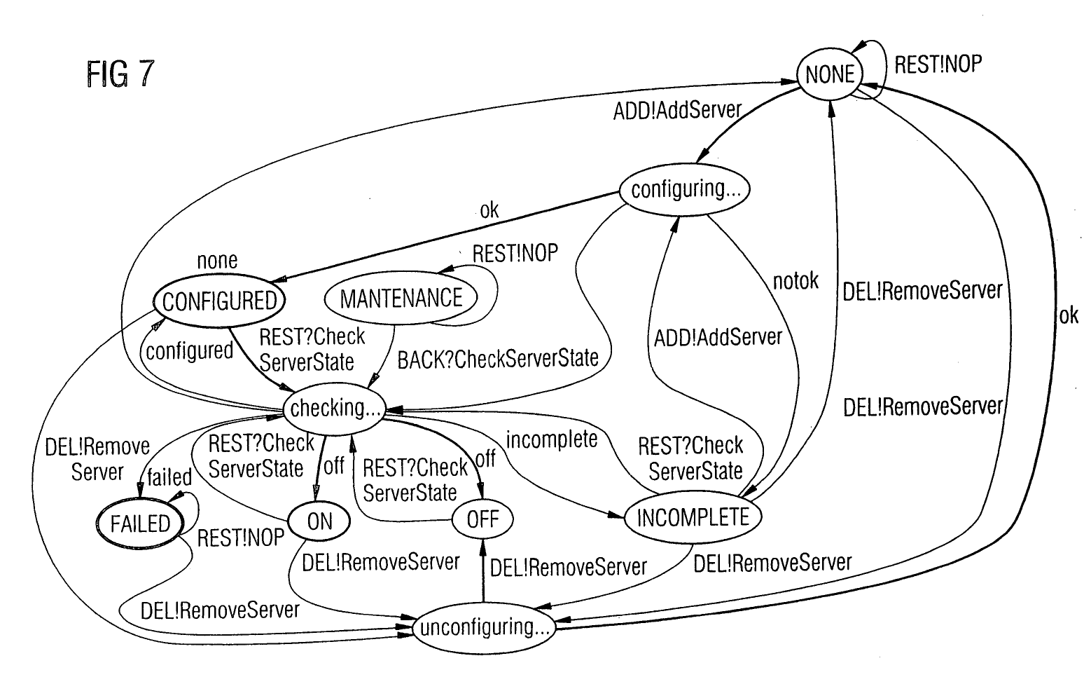

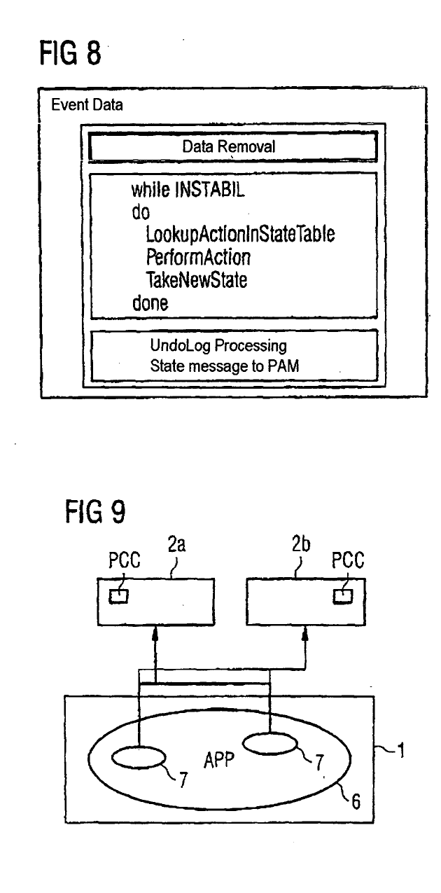

After the desired action has been started, the individual commands are worked on and an UNDO log is written (FIG. 8). For synchronisation during work on the database the scripts which are implementing the action use the concept of critical regions. The passage through all program regions which are processing data, which are potentially also available to other actions is sequentialised by semaphores.

As specified above, a data processing system according to the invention especially has the advantages that a control of the entire data processing system is formed, which

is detached from that being controlled and can be highly available,

operates with finite automata/sample graphs which are automatically configured, created and destroyed,

can execute every type of process control by means of state graphs especially with the aid of intelligent nodes and

supports parallel event processings and also allows changes of graphs under defined conditions.

These part aspects are now explained in detail.

The features of the proposed data processing system which are important to the invention can substantially be implemented as software. However, it is a special feature of the data processing system in the preferred embodiment that the automaton control component does not run inside the machines to be controlled themselves but on precisely two detached machines 2a and 2b (FIGS. 2 and 9). The control software itself is designed as highly available. It is thus subject to no influences from the world to be controlled. In particular, there is no need to keep up with the development of the processes to be controlled. Since the number of machines to be controlled is limited to precisely two, the basic algorithms in the high availability region are frequently trivial. For further simplification, only one control instance is active at one time.

A further important feature of the proposed solution is that no implants of the control system are required within the process to be controlled, i.e., no intervention is required in the structure of the components to be controlled. In this case, it is important to establish that as a result of the necessary control loop implants are required in principle but as a result of the choice of SNMP as event carriers, the necessary implants 7 are already present in all important applications 6, as shown in FIG. 9. A further advantage of SNMP is that this protocol is machine-independent, i.e. not bound to a certain processor type, a certain operating system or a certain data type. In the application 6, elements 7 are present which fulfil the function of implants. These elements 7 are built into the application 6 at the manufacturers without it depending whether the function of the implants 7 is required in later operation. The implants detect certain states and generate corresponding messages which they make available via a stipulated interface. In this embodiment, SNMP is used as the interface, which means that the implant sends messages according to the SNMP standard and the control software understands messages according to the SNMP standard. The control software PCC on the control computers 2a and 2b is set up to receive and process the prepared messages.

In the specific embodiment described here, two separate machines 2a and 2b are provided on which the control software PCC runs. Both machines 2a and 2b are operated in a conventional manner as clusters. The control software PCC is coupled to the server farm 1 via SNMP events. The event-transmitting components are not part of the control software PCC but belong directly to the applications to be controlled, such as for example to ORACLE because the precise knowledge about the function of the application is present there alone. Thus, the machines of the server farm 1 to be controlled are free from monitoring software and are thus substantially easier to administer with respect to coordinating changes with the control software. The frequently insidious multiplicity of versions then creates far fewer problems. Instead of this configuration, other configurations are naturally also within the discretion of the person skilled in the art and are covered by the invention. For example, the provision of an implant and another way of transmitting events could be considered.

It is important that the sample graphs themselves are freed from any direct link to the process to be controlled via attributes of the node. Thus, a sample graph only consists of states and edges which can be arbitrarily named. These sample graphs can be generated and operated arbitrarily frequently. The references to the real world are only made when generating the graph.

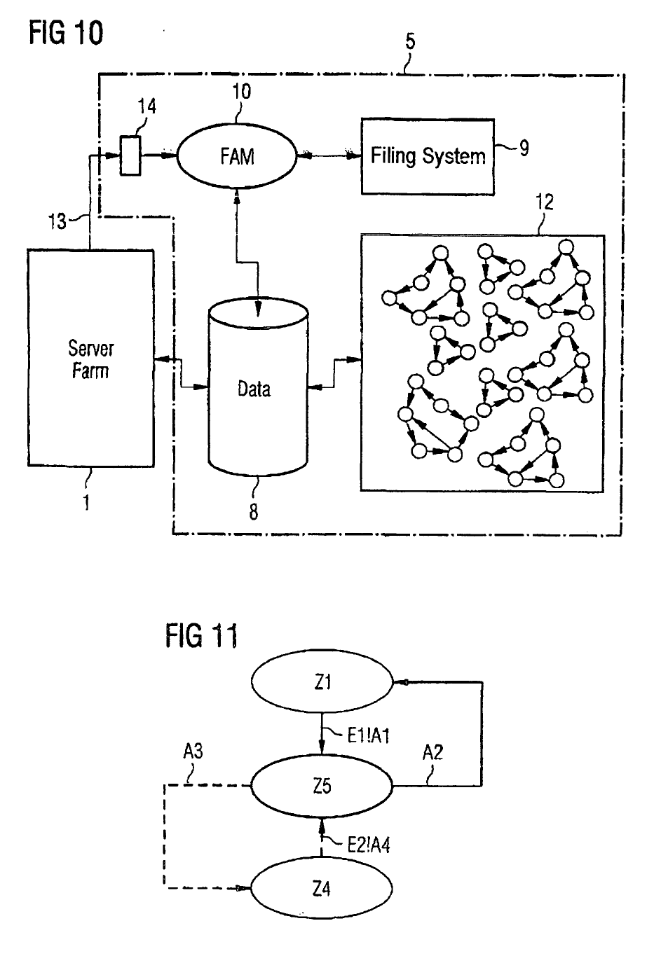

The most important part of the solution is the automaton-controlled component 5 which is built into the control software PCC (FIG. 10). This receives events 13 from the processes to be controlled from the server farm 1 and creates, if necessary, new finite automata if a hitherto unknown process to be controlled, for example a software component of an application or a hardware component of a monitoring service, has logged on. For this purpose the automaton manager 10 of the automaton control component 5 extracts the necessary configuration data either from the event itself 13 or it obtains the necessary data from the process to be controlled. The data are filed in a database 8 which can be constructed very simply, for example, it can consist of a text file. However, more complex types of database can also be used. Then a finite automaton can be created and the control of the processes begins with the current references to the real world. This process is called configuration of a finite automaton.

Here there is major difference from the known cluster managers because there each new finite automaton must be built manually and provided with references to the real world. Basically the expenditure with the new data processing system according to the invention is confined to the compilation of a simple sample graph which can be used for many types of processes to be controlled since both the event-transmitting parts and the action carriers are parts of the process to be controlled and no longer part of the control software. Thus, the command to start an application, for example in the software control area does not depend on which version of an application is to be started. This is observed during running of the action under the responsibility of the application.

During the configuration the finite automaton is named as described above and the data and automaton are interlinked via this name. The finite automata are thereby linked to ‘their’ process or ‘their’ application. In particular, the current state of an automaton itself is also filed in the database.

The creation of finite automata can be influenced. Events can be permanently or temporarily blocked, events can, for example, be filtered out for safety reasons and the generation rate can be slowed. For this purpose a filter 14 is provided. This is also instigated by the finite automata themselves and implemented by the automaton control component 5.

Finite automata are also destroyed automatically.

In the specific embodiment from FIG. 10 the SNMP events 13 are recorded by the automaton control component 5 which has a filing system 9. There the allocation of an event to a sample graph and an action is filed. New finite automata are substantially created by recording their events and applying their data. The incoming events 13 can be processed with dynamically loadable filters 14, Allocations can be dynamically changed or also deleted via the filing system 9 of the automaton control component 5. The generation rate can be controlled via the internal statistics of the automaton control component and the automaton control component 5 can dynamically load libraries, pre-process or filter out the events (spamming).

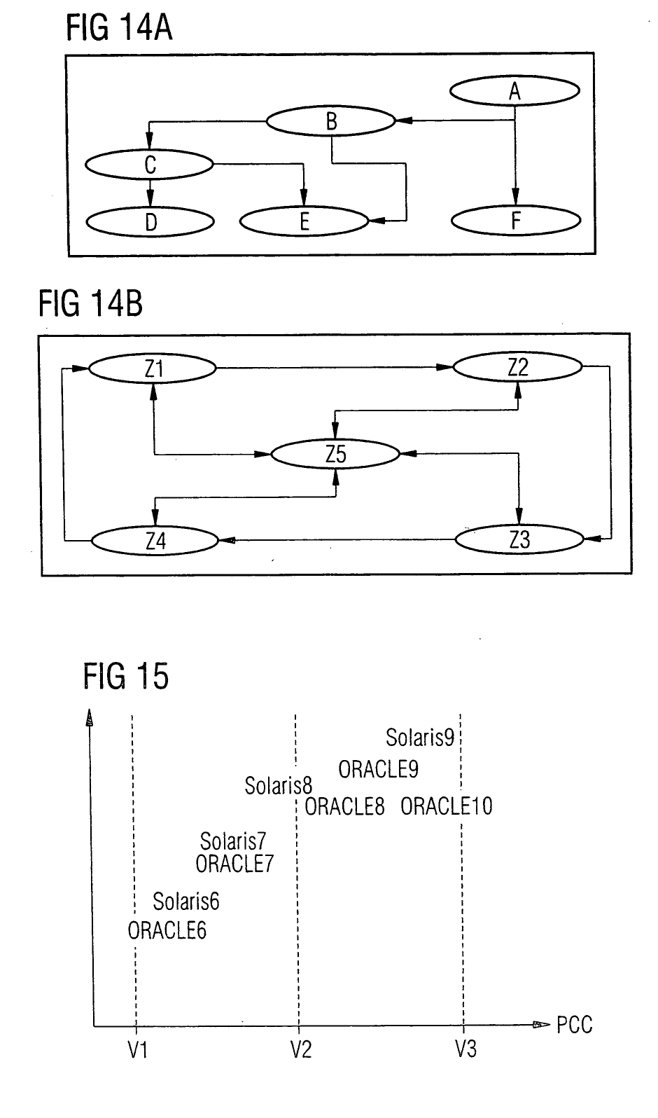

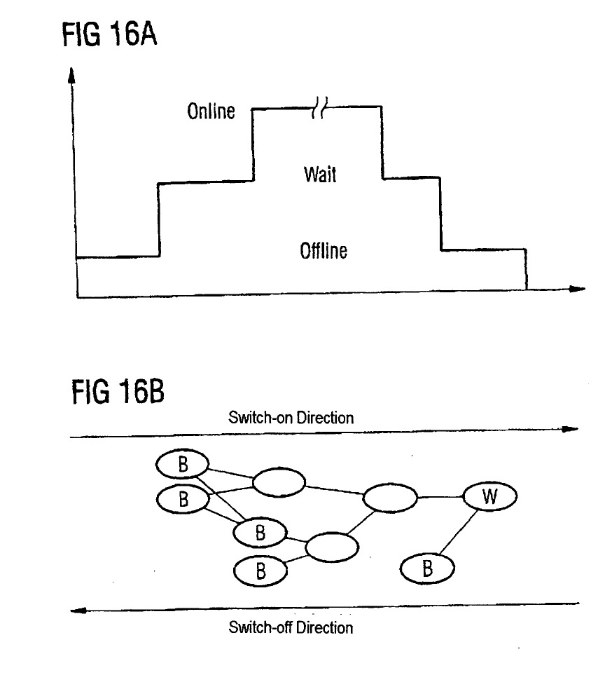

In contrast to the dependence graphs, in state graphs it is precisely stipulated via which edge the change from one state to the next takes place. Normally the nodes of the graphs have no intelligence. However, with the introduction of intelligent nodes which are capable of independently making a decision as to the edge to be selected via which the next change of state takes place, a new type of property appears in the graphs which makes a decisive contribution to the simplification. Thus, for example, the node in accordance with the state Z5 in FIG. 14B or in the detailed FIG. 11 can be regarded as a ‘sweeper’. In the case of every error event in one of the states Z1 to Z4, the graph goes into the state Z5, decides on the present situation and branches if necessary whilst executing a cleaning action into a ‘stable’ state Z1 to Z4. The type of decision is not specified. Everything is possible from simple Boolean logic to fuzzy logic. In addition, this node also has available to it access to any actions with the aid of which, for example, the actual situation in the ‘real world’ or the process to be controlled can be checked.

This type of graph is very advantageous precisely in the SNMP world. For example, when contradictory events occur as a result of overtaking processes, synchronisation thus takes place and ‘old’ events cause no more damage.

In contrast to graphs, where a node merely serves as a observer of the current state, the nodes in this environment have at least a minimum amount of ‘intelligence’ to be able to implement complex functions, as has been described above.

The finite automata themselves have no knowledge of their environment and cannot communicate directly with one another and in particular, they cannot have an influence among one another, that is change their machine tables. At this point, it should be noted however that it is theoretically completely possible to change their own or another graph but here we are leaving the area of finite automata to change into the area of neural networks where completely different conditions apply and where science certainly still requires more time to master the topic. In any case, an automaton manager can completely take over or at least coordinate the parts of this task, for example, expansion of machine tables, which are concerned with the pure communication problems of finite automata among one another.

For this purpose, according to the invention each node of an automaton has access to the database 8 and can not only enquire about the states of all other finite automata but can also influence these. Information on individual finite automata can be transmitted to any others via functions of the automaton control component 5. The recording of finite automata and events can be changed, the number of events to be processed in parallel can be influenced, singular finite automata can register to be informed of the generation of new finite automata, if necessary filter libraries 14 can be dynamically loaded into the automaton control component 5 or removed again. All finite automata of a sample can have a ‘family state’ which, in the event of every activation of a finite automaton, can be transferred from this family and changed. These possibilities are substantially obtained through the presence of the automaton control component which as a superordinate instance organises or supports the quantity of individual finite automata. The database 8 serves as a second basis through which all finite automata can have access to any type of data.

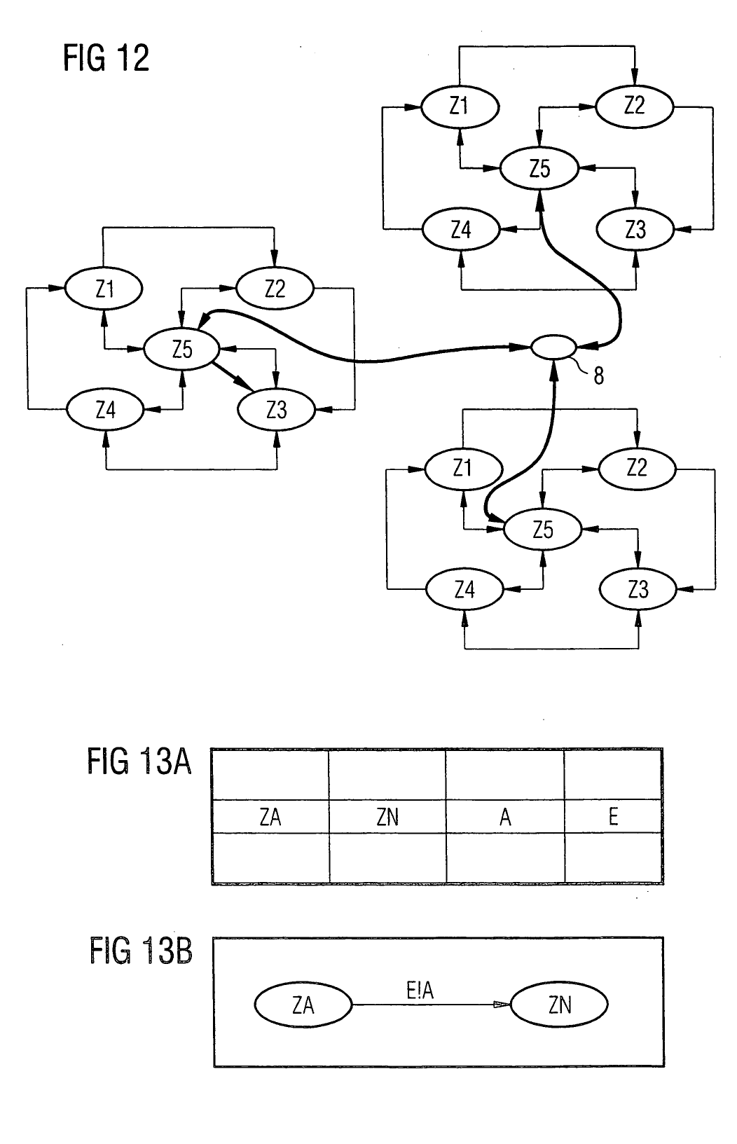

The individual finite automata are organised so that every event is processed immediately. Events are not parked. Thus, a finite automaton can exist in several instances at the same time. In critical situations all events are always submitted to the finite automaton and in communication among one another the ‘correct’ decision can be made as to the action to be selected and an instance takes over the implementation (see bold arrows in FIG. 12 from state Z5 to state Z3). The others end the processing. Thus, for example, situations can be debugged in which an error in the server farm brings about more than a consequent error which is processed in the different finite automata.

In particular, the intelligence of decision nodes is filed as datum like all others in the database 8 and can thus be varied. This also relates to the machine table or the graphs. This need not necessarily be meaningful in normal operation but can then be extremely interesting when conclusions are to be drawn from load profiles which should be incorporated permanently in the behaviour of finite automata. This point is not considered further in this document because the important thing is less the possibility of variation itself but rather how suitable conclusions can be drawn from present load profiles.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

1. A data processing system with a plurality of hardware and software components, wherein the components can be controlled by finite automata, such system comprising:
at least one finite sample automaton adapted to be suitable for controlling and monitoring pre-determined component types, wherein finite automata can be configured for the control of one component on the basis of the defined sample automaton(automata) in conjunction with component-specific parameters, and
an event-controlled automaton control component (5) which is constructed for the configuration, instantiation and deletion of finite automata.

2. The data processing system according to claim 1, wherein means are provided for cloning finite sample automata for new hardware or software components.

3. The data processing system according to claim 1, wherein sample automata contain special nodes (Z5, checking . . . ) which make a branching possible.

4. The data processing system according to claim 3, wherein the special nodes (Z5, checking . . . ) are constructed such that, and arranged in the sample automaton such that, an error handling is executed by them.

5. The data processing system according to claim 1, characterised in that the automaton control component (5) is formed by a finite automaton wherein state changes are triggered by received events (13).

6. The data processing system according to claim 5, wherein the automaton control component (5) contains special nodes which make a branching possible.

7. The data processing system according to claim 6, wherein that dynamically loadable event filters (14) are provide to filter out events (13) classified as irrelevant.

8. The data processing system according to claim 1, wherein parameters are recorded for pre-determined events and the recorded parameters are used to process the event.

9. The data processing system according to claim 8, wherein for processing different events (13) a same finite automaton is provided in conjunction with the event-specific parameters.

10. The data processing system according to claim 1, wherein events sent to the automaton control component (5) are created automatically by state sensors (7) which are allocated hardware components, services or applications.

11. The data processing system according to claim 1, wherein means are provided for manual generation of events to be sent to the automaton control component.

12. The data processing system according to claim 1, wherein the events (13) are transmitted by means of the Simple Network Management Protocol.

13. The data processing system according to claim 1, wherein a server farm (1) is formed by components of the data processing system.

14. The data processing system according to claim 13, wherein the automaton control component (5) is arranged on a separate computer unit (2a, 2b) which is not part of the server farm (1).

15. The data processing system according to claim 14, wherein the separate computer unit (2a, 2b) for its part is formed by a highly available cluster.

16. A method for controlling a data processing system with a plurality of hardware and software components, wherein the components can be controlled by finite automata, such method comprising:
defining at least one finite sample automaton adapted to be suitable for controlling and monitoring pre-determined component types, wherein finite automata can be configured for the control of one component on the basis of the defined sample automaton(automata) in conjunction with component-specific parameters, and
applying an event-controlled automaton control component (5) to configure, instantiate or delete the finite automaton(s).

17. The method according to claim 16, wherein the automaton control component (5) is executed as highly available.

18. The method according to claim 17, wherein the automaton control component (5) is executed on a separate computer unit (2a, 2b).

19. The method according to claim 16, wherein the automaton control component (5) operates by means of a finite automaton which has the state node (checking . . . ) which allows branchings.
